(19) United States
(12) Patent Application Publication
(10) Pub. No.: US 2011/0192324 A1
(43) Pub. Date: Aug. 11, 2011

(54) DEVICE FOR USE AT TEMPERATURES ABOVE 1000°C OR IN MOLTEN STEEL

(75) Inventor: Johan KNEVELS, Bree (BE)

(73) Assignee: HERAEUS ELECTRO-NITE INTERNATIONAL N.V., Houthalen (BE)

(21) Appl. No.: 13/089,515

(22) Filed: Apr. 19, 2011

Related U.S. Application Data
(62) Division of application No. 12/174,733, filed on Jul. 17, 2008.

(30) Foreign Application Priority Data
Jul. 17, 2007 (DE) 10 2007 033 622.7

(51) Int. Cl. C04B 14/22; B22C 1/00; B22C 9/10; C04B 28/06; C04B 12/02; C04B 18/06

(52) U.S. Cl. 106/691; 164/529; 106/814; 106/692; 106/782; 106/705

(57) ABSTRACT

A device is provided for use at temperatures above 1000° C. or in steel melts. The device has a body based on a material selected from at least one of high temperature-resistant hollow balls and high temperature-resistant hollow fibers. The body further contains water glass and a cement.

### CROSS-REFERENCE TO RELATED APPLICATIONS

This application is a divisional of co-pending U.S. application Ser. No. 12/174,733, filed Jul. 17, 2008, the disclosure of which is incorporated herein by reference.

### BACKGROUND OF THE INVENTION

The invention relates to a device for use at temperatures above 1000° C. or in molten steel, wherein the device has a body based on sand and/or high temperature-resistant hollow balls and/or high temperature-resistant hollow fibers.

From British patent specification GB 782205 hollow cores are known from foundry technology, which are formed from a mixture of sand and a water glass binder and also organic materials.

Devices according to the generic type can serve as bodies for measurement heads, such as those disclosed in German Patent DE 10 2004 022 763 B3.

Similar devices are also known from German Patent DE 10 2005 060 493 B3.

Known devices have binding agents containing, to a large extent, organic materials, which can release phenol-bearing or ammonia-bearing gases during production.

### BRIEF SUMMARY OF THE INVENTION

An object of the present invention is to provide an improved device for high temperatures or for molten steel, which is improved with respect to effects on the environment and health, in comparison with known devices.

The object is achieved, according to the invention, by a device having a body, which is formed on the basis of sand and/or high temperature-resistant hollow balls and/or high temperature-resistant hollow fibers and which contains water glass and an (inorganic) cement.

### DETAILED DESCRIPTION OF THE INVENTION

As used herein, high-temperature resistance is understood to be a mechanical and chemical resistance at temperatures of approximately 1000 to 1700° C. for a duration of at least 5 seconds at a temperature of 1700° C., which is the time needed, for example, for taking a sample, as well as for a duration of up to 5 minutes at a temperature of 1000° C. Surprisingly, it has been shown that such bodies also remain mechanically stable for long-term storage, while prior tests with resin-free binding agents do not lead to a body, which can be stored and which remains mechanically stable. It has been shown that bodies according to the invention are not only stable in storage, but also exhibit sufficient stability in later use. They emit during their production practically no materials that are harmful to the environment or health. The materials are easily processed into molded bodies.

In addition, it has been shown that devices according to the invention used as sample chambers are indeed, on the one hand, mechanically stable, so that an uncomplicated sampling is guaranteed. On the other hand, such bodies can be easily destroyed due to select, external effects, in order to remove the samples from their interior. By use of ceramic bodies, for example, this is not possible without additional means. In addition, it has been shown that the samples are only extremely minimally affected with respect to their carbon content. Therefore, the devices according to the invention are surprisingly well suited as samplers and/or measurement deices for steel melts, in particular for steel melts with a carbon content of less than 100 ppm. It has been shown that the body of devices according to the invention can be produced very reliably and durably by core shooting.

Preferably, the body contains a high-alumina cement, in particular a cement selected from the group calcium-aluminate cement, Portland cement, and phosphate cement. Portland cement is also designated as a blast furnace cement. As a reaction accelerator, the body of the device according to the invention can contain lithium carbonate, calcium chloride, sodium chloride, or gypsum in small quantities of preferably at the most one weight % in total.

As additional binding intensifiers fly ash and/or silicic acid can be used, in particular with a proportion of at most 10 wt. %. In addition, a separating agent can be included advantageously for easier removal of the body from the production device. The separating agent (for example, Teflon or an oil) is advantageously present in a proportion of at most 0.5 wt. %.

It is further expedient that water glass in a proportion of 5-15 wt. % and cement in a proportion of 10-20 wt. % be present. The sand, the hollow balls, and/or the hollow fibers are advantageously provided in a proportion of at most 75 wt. %. The sand can be, in particular, so-called foundry sand or molding sand. The grain size should expediently lie between 90 and 700 μm, in particular should amount to 200-300 μm.

The hollow balls and/or hollow fibers are advantageously formed of aluminum oxide or aluminum silicate. The sand, the hollow balls, and/or the hollow fibers are advantageously present in a proportion of 55-75 wt. %, preferably in a proportion of 60-70 wt. %.

Such a body can be used very well in a device for immersion in steel melts, if a so-called non-splash material must be used, in order to keep the effects on the surroundings low.

Embodiments of the invention will be described below.

The device according to the invention can be constructed as described, for example, in German Patents DE 10 2004 022 763 B3 or DE 10 2005 060 493 B3. Other structures are also conceivable. The device described in DE 10 2005 060 493 B3 is suitable both for measurement and for sampling in molten metals, particularly in steel melts or in slags.

According to one embodiment, the body of the device according to the invention can be formed of:

65 wt. % foundry sand

15 wt. % Portland cement

10 wt. % silicic acid

9 wt. % soda water glass

0.7 wt. % calcium chloride

0.3 wt. % separating agent.

According to another embodiment, the body according to the invention can be composed as follows:

75 wt. % molding sand

10 wt. % high-alumina cement

14 wt. % potassium silicate (water glass)

0.6 wt. % sodium chloride

0.4 wt. % separating agent.

Another embodiment of a device according to the invention has a body with the following composition:

70 wt. % hollow balls or hollow fibers made of aluminum oxide or aluminum silicate

20 wt. % phosphate cement

9 wt. % soda water glass

0.5 wt. % gypsum

0.5 wt. % separating agent.

As the separating agent in the above embodiments, Teflon can be used, for example.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A device for use at temperatures above 1000° C. or in steel melts, the device comprising a body based on a material selected from at least one of high temperature-resistant hollow balls and high temperature-resistant hollow fibers, the body further containing water glass and a cement.

2. The device according to claim 1, wherein the cement comprises a high-alumina cement.

3. The device according to claim 2, wherein the high-alumina cement is selected from calcium aluminate cement, Portland cement, and phosphate cement.

4. The device according to claim 1, wherein the body further contains a reaction accelerator selected from lithium carbonate, calcium chloride, sodium chloride and gypsum.

5. The device according to claim 1, wherein the body further contains at least one of fly ash, silicic acid and a separating agent.

6. The device according to claim 1, wherein water glass is present in a proportion of 5-15 wt. % and cement is present in a proportion of 10-20 wt. %, based on the total weight of the body.

7. The device according to claim 1, wherein the hollow balls and/or hollow fibers are present in a proportion of at most 75 wt. % of the total weight of the body.

8. The device according to claim 7, wherein the hollow balls and/or hollow fibers are present in a proportion of 60 to 70 wt. % of the total weight of the body.

9. The device according to claim 4, wherein lithium carbonate, calcium chloride, sodium chloride, and/or gypsum are present in a total proportion of at most 1 wt. % of the total weight of the body.

10. The device according to claim 5, wherein fly ash and/or silicic acid are present in a proportion of at most 10 wt. % of the total weight of the body.

11. The device according to claim 5, wherein the separating agent is present in a proportion of at most 0.5 wt. % of the total weight of the body.

12. The device according to claim 1, wherein the hollow balls or hollow fibers are based on a material selected from aluminum oxide and aluminum silicate.

13. The device according to claim 1, wherein the body comprises a sampler and/or measurement device for steel melts.

14. The device according to claim 1, wherein the body is designed for use in steel melts having a carbon content of less than 100 ppm.

15. A method for producing a body of a device according to claim 1, the method comprising forming the body by core shooting.
